(19) United States
(12) Patent Application Publication
(10) Pub. No.: US 2004/0127294 A1
(43) Pub. Date: Jul. 1, 2004

(54) Power transmission

(76) Inventors: Takahiro Ohta, Ashikaga-shi (JP); Masazumi Ishikawa, Nitta-gun (JP); Hideyuki Gonda, Isesaki-shi (JP)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/735,715

(22) Filed: Dec. 16, 2003

(30) Foreign Application Priority Data
Dec. 25, 2002 (JP) 2002/375382
Dec. 25, 2002 (JP) 2002/375383

(51) Int. Cl. F16D 7/02

(52) U.S. Cl. 464/41

(57) ABSTRACT

A power transmission includes a first rotating member having one or more first concave portions formed on an inner circumferential surface of the first rotating member. The power transmission also includes a second rotating member having one or more second concave portions formed on an outer circumferential surface of the second rotating member. Moreover, the power transmission includes a holding member positioned within the second concave portion, and a connecting member slidably held by the holding member. Specifically, when an amount of torque transmitted to the first rotating member is less than or equal to a predetermined amount of torque a particular portion of the connecting member is in contact with a wall of the first concave portion to prevent a rotation of the first rotating member with respect to the second rotating member. Moreover, when the amount of torque transmitted to the first rotating member is greater than the predetermined amount of torque the connecting member is positioned within the second concave portion, the connecting member resiliently deforms the holding member, and the particular portion of the connecting member is disengaged from the wall of the first concave member to allow the first rotation member to rotate with respect to the second rotation member.

### BACKGROUND OF THE INVENTION

1. Field of the Invention

The present invention relates generally to a power transmission for use in rotary equipment.

2. Description of Prior Art

A power transmission, such as the power transmission described in Japanese Patent No. JP-A-2001-153142, includes a first rotating member. The first rotating member has an annular shape, and includes a first concave portion formed on its inner circumferential surface. The known power transmission also includes a second rotating member. The second rotating member has a disc-like shape, and includes a second concave portion formed on its outer circumferential surface. The second rotating member is slidably fitted into the first rotating member. The known power transmission further includes a press ring, a belleville spring which applies a pressure to the press ring, and a connecting member which is held by the press ring and the second concave portion. In the known power transmission, when a torque is transmitted, the connecting member engages a wall of the first concave portion to prevent a relative rotation between the first rotating member and the second rotating member. When the transmission of the torque is interrupted, the wall of the first concave portion applies a pressure to the connecting member, the connecting member deforms the belleville spring and moves into the second concave portion. The connecting member also disengages from the wall of the first concave portion, which allows the relative rotation between the first rotating member and the second rotating member.

In the known power transmission, the use of the press ring and the belleville spring to engage the connecting member with the wall of the first concave portion during torque transmission, and to position the connecting member in the second concave portion during torque interruption, increases the size of the power transmission in the axial direction. Consequently, the size of a rotary equipment which uses the known power transmission increases in the axial direction.

Another known power transmission, such as the power transmission described in Japanese Patent No. JP-A-10-311391, includes a first rotating member. The first rotating member has an annular shape, and includes a first concave portion formed on its inner circumferential surface. This known power transmission also includes a second rotating member. The second rotating member has a disc-like shape, and includes a second concave portion. The second concave portion has an entrance portion, and a width of the entrance portion is less than an internal width of the second concave portion. The second rotating member is slidably fitted into the first rotating member. Moreover, this known power transmission includes a resilient member. Specifically, when a torque is transmitted, the resilient member engages each of a wall of the first concave portion and the entrance portion of the second concave portion, which prevents a relative rotation between the first rotating member and the second rotating member. When the transmission of the torque is interrupted, the wall of the first concave portion applies a pressure to the resilient member, and the resilient member deforms. The resilient member also moves into the second concave portion via the entrance portion of the second concave portion, and disengages from the wall of the first concave portion, which allows the relative rotation between the first rotating member and the second rotating member.

In this known power transmission, when the amount of torque transmitted from the first rotating member to the second rotating member is greater than a predetermined torque value, the transmission of torque from the first rotating member to the second rotating member is interrupted. Consequently, the likelihood that a drive source, the connecting member between the drive source and the first rotating member, or the like, may be damaged, is reduced.

Nevertheless, these known power transmissions may be unable to suppress a torque variation of the drive source connected to the first rotating member, and also may be unable to suppress a torsional vibration of the main shaft of the rotary equipment, which is caused by the torque variation of the drive shaft.

### SUMMARY OF THE INVENTION

Therefore, a need has arisen for a power transmission which overcomes these and other shortcomings of the related art. A technical advantage of the present invention is that the power transmission may not increase the size of an axial dimension of the rotary equipment. Another technical advantage of the present invention is that the power transmission may suppress a torque variation of the drive source, and also may suppress the torsional vibration of the main shaft of the rotary equipment.

According to an embodiment of the present invention, a power transmission comprises a first rotating member comprising at least one first concave portion formed on an inner circumferential surface of the first rotating member. The power transmission also comprises a second rotating member comprising at least one second concave portion formed on an outer circumferential surface of the second rotating member. Moreover, the power transmission comprises a holding member positioned within the at least one second concave portion, and a connecting member slidably held by the holding member. Specifically, when an amount of torque transmitted to the first rotating member is less than or equal to a predetermined amount of torque a particular portion of the connecting member is in contact with a wall of the at least one first concave portion to prevent a rotation of the first rotating member with respect to the second rotating member. Moreover, when the amount of torque transmitted to the first rotating member is greater than the predetermined amount of torque the connecting member is positioned within the at least one second concave portion,.the connecting member resiliently deforms the holding member, and the particular portion of the connecting member is disengaged from the wall of the at least one first concave member to allow the first rotation member to rotate with respect to the second rotation member.

According to another embodiment of the present invention, a power transmission comprises a first rotating member comprising at least one first concave portion formed on an inner circumferential surface of the first rotating member. The power transmission also comprises a second rotating member comprising at least one second concave portion formed on an outer circumferential surface of the second rotating member. Moreover, the power transmission comprises a holding member positioned within the at least one first concave portion, and a connecting member slidably held by the holding member. Specifically, when an amount of torque transmitted to the first rotating member is less than or equal to a predetermined amount of torque a particular portion of the connecting member is in contact with a wall of the at least one second concave portion to prevent a rotation of the first rotating member with respect to the second rotating member. Moreover, when the amount of torque transmitted to the first rotating member is greater than the predetermined amount of torque the connecting member is positioned within the at least one first concave portion, the connecting member resiliently deforms the holding member, and the particular portion of the connecting member is disengaged from the wall of the at least one second concave member to allow the first rotation member to rotate with respect to the second rotation member.

According to yet another embodiment of the present invention, a power transmission comprises a first rotating member comprising at least one first concave portion formed on an inner circumferential surface of the first rotating member. The power transmission also comprises a second rotating member comprising at least one second concave portion formed on an outer circumferential surface of the second rotating member, in which the at least one second concave portion comprises an entrance portion having a width which is less than an interior width of the at least one second concave portion. Moreover, the power transmission comprises a resilient member slidably held by the entrance portion, and the resilient member comprises means for damping. Specifically, when an amount of torque transmitted to the first rotating member is less than or equal to a predetermined amount of torque a particular portion of the resilient member is in contact with a wall of the at least one first concave portion to prevent a rotation of the first rotating member with respect to the second rotating member. Moreover, when the amount of torque transmitted to the first rotating member is greater than the predetermined amount of torque the resilient member is positioned within the at least one second concave portion, the at least one first concave portion resiliently deforms the resilient member, and the particular portion of the resilient member is disengaged from the wall of the at least one first concave member to allow the first rotation member to rotate with respect to the second rotation member.

According to still another embodiment of the present invention, a power transmission comprises a first rotating member comprising at least one first concave portion formed on an inner circumferential surface of the first rotating member, in which the at least one first concave portion comprises an entrance portion having a width which is less than an interior width of the at least one first concave portion. The power transmission also comprises a second rotating member comprising at least one second concave portion formed on an outer circumferential surface of the second rotating member. Moreover, the power transmission comprises a resilient member slidably held by the entrance portion, and the resilient member comprising means for damping. Specifically, when an amount of torque transmitted to the first rotating member is less than or equal to a predetermined amount of torque a particular portion of the resilient member is in contact with a wall of the at least one second concave portion to prevent a rotation of the first rotating member with respect to the second rotating member. Moreover, when the amount of torque transmitted to the first rotating member is greater than the predetermined amount of torque the resilient member is positioned within the at least one first concave portion, the at least one second concave portion resiliently deforms the resilient member, and the particular portion of the resilient member is disengaged from the wall of the at least one second concave member to allow the first rotation member to rotate with respect to the second rotation member.

According to still yet another embodiment of the present invention, a power transmission comprises a first rotating member comprising at least one first concave portion formed on an inner circumferential surface of the first rotating member. The power transmission also comprises a second rotating member comprising at least one second concave portion formed on an outer circumferential surface of the second rotating member, in which the at least one second concave portion comprises an entrance portion having a width which is less than an interior width of the at least one second concave portion. Moreover, the power transmission comprises a resilient member slidably held by the entrance portion, and the resilient member comprises means for preventing the resilient member from rotating. Specifically, when an amount of torque transmitted to the first rotating member is less than or equal to a predetermined amount of torque a particular portion of the resilient member is in contact with a wall of the at least one first concave portion to prevent a rotation of the first rotating member with respect to the second rotating member. Moreover, when the amount of torque transmitted to the first rotating member is greater than the predetermined amount of torque the resilient member is positioned within the at least one second concave portion, the at least one first concave portion resiliently deforms the resilient member, and the particular portion of the resilient member is disengaged from the wall of the at least one first concave member to allow the first rotation member to rotate with respect to the second rotation member.

According to yet a further embodiment of the present invention, a power transmission comprises a first rotating member comprising at least one first concave portion formed on an inner circumferential surface of the first rotating member, in which the at least one first concave portion comprises an entrance portion having a width which is less than an interior width of the at least one first concave portion. The power transmission also comprises a second rotating member comprising at least one second concave portion formed on an outer circumferential surface of the second rotating member. Moreover, the power transmission comprises a resilient member slidably held by the entrance portion, and the resilient member comprises means for preventing the resilient member from rotating, wherein when an amount of torque transmitted to the first rotating member is less than or equal to a predetermined amount of torque a particular portion of the resilient member is in contact with a wall of the at least one second concave portion to prevent a rotation of the first rotating member with respect to the second rotating member. Moreover, when the amount of torque transmitted to the first rotating member is greater than the predetermined amount of torque the resilient member is positioned within the at least one first concave portion, the at least one second concave portion resiliently deforms the resilient member, and the particular portion of the resilient member is disengaged from the wall of the at least one second concave member to allow the first rotation member to rotate with respect to the second rotation member.

Other objects, features, and advantage will be apparent to persons of ordinary skill in the art from the following detailed description of the invention and the accompanying drawings.

### BRIEF DESCRIPTION OF THE DRAWINGS.

For a more complete understanding of the present invention, the needs satisfied thereby and the objects features, and advantages thereof, reference now is made to the following description taken in connection with the accompanying drawings.

FIG. 1 is a perspective view of a power transmission according to an embodiment of the present invention.

FIGS. 2A-2H are plan views of a connecting member according to a first plurality of embodiments of the present invention.

FIGS. 3A-3E are plan views of a connecting member according to a second plurality of embodiments of the present invention.

FIGS. 4A and 4B are perspective views of a holding member according to a plurality of embodiments of the present invention.

FIG. 5 is a perspective view of a power transmission according to another embodiment of the present invention.

FIGS. 6A-6E are plan views of a resilient member according to a first plurality of embodiments of the present invention.

FIGS. 7A and 7B are plan views of resilient members according to a second plurality of embodiments of the present invention.

FIGS. 8A-8C are plan views of resilient members according to a third plurality of embodiments of the present invention.

FIG. 9 is a plan view of a resilient member according to a fourth plurality of embodiments of the present invention.

FIGS. 10A and 10B are plan views of resilient members according to a fifth plurality of embodiments of the present invention.

### DETAILED DESCRIPTION OF PREFERRED EMBODIMENTS

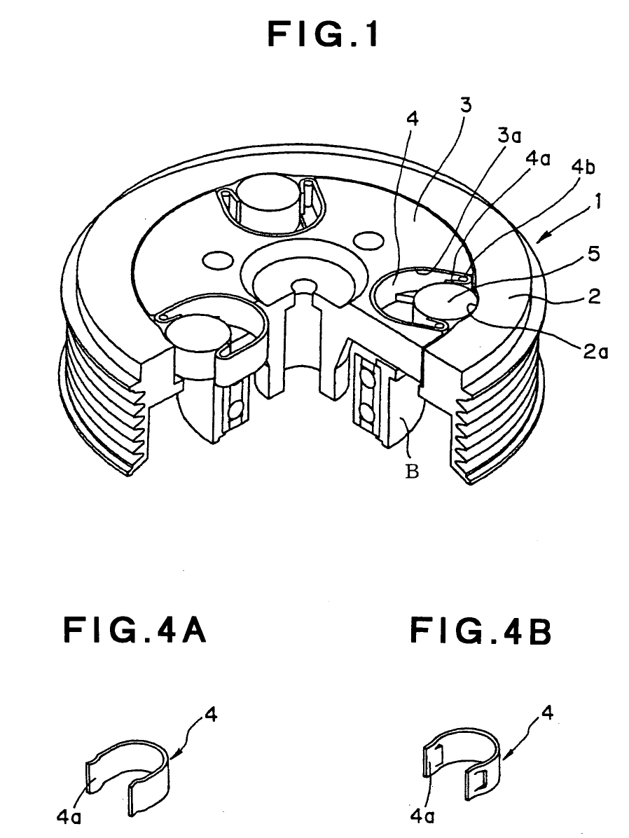

Preferred embodiments of the present invention and their features and advantages may be understood by referring to FIGS. 1-10B, like numerals being used for like corresponding parts in the various drawings.

Referring to FIG. 1, a power transmission 1 according to an embodiment of the present invention is depicted. Power transmission 1 may comprise a first rotating member 2. First rotating member 2 may be supported by a casing of a rotary equipment (not shown), such as a compressor, via a bearing B. First rotating member 2 may be connected to a drive source (not shown), such as an engine of a vehicle, via an endless belt (not shown). In this embodiment, first rotating member 2 may have at least one first concave portion 2a formed on an inner circumferential surface of first rotating member 2. For example, there may be about three first concave portions 2a, and each first concave portion 2a may be arc-shaped.

Power transmission 1 also may comprise a second rotating member 3. Second rotating member 3 may have a disc-like shape, and may be slidably fitted into first rotating member 2. In this embodiment, second rotation member 3 may have at least one second concave portion 3a formed on an outer circumferential surface of second rotating member 3, such that second concave portion 3a faces first concave portion 2a. For example, there may be about three second concave portions 3a, and each second concave portion 3a may be semi-ellipse shaped. A main shaft of the rotary equipment may be fixed to the center of second rotating member 3.

A holding member 4 may be positioned within second concave portion 3a, such that the shape of holding member 4 corresponds to the shape of second concave portion 3a. Each end of holding member 4 may be folded to form a pair of substantially u-shaped ends 4a. Moreover, a pair of rod-like members 4b may be held by a corresponding one of ends 4a, such that each end 4a may function as a spring.

A connecting member 5 may be held by holding member 4, such that connecting member 5 contacts each end 4a of holding member 4. Connecting member 5 may have a disc-like shape. A first portion of connecting member 5 may be positioned within first concave portion 2a and may contact a wall of first concave portion 2a, and a second portion of connecting member 5 may be positioned within second concave portion 3a. For example, the second portion may be greater than the first portion. Moreover, the radius of curvature of first concave portion 2a may be greater than the radius of curvature of the first portion. Alternatively, the radius of curvature of second concave portion 3a may be greater than the radius of curvature of second concave portion 2a.

In operation, the drive source transmits the torque to first rotating member 2 via the endless belt. Connecting member 5 then contacts the wall of first concave portion 2a, such that connecting member 5 prevents the relative rotation between first rotating member 2 and second rotating member 3. Consequently, the torque is transmitted from first rotating member 2 to second rotating member 3 via first concave portion 2a, connecting member 5, holding member 4, and second concave portion 3a. The torque then is transmitted from second rotating member 3 to the main shaft of the rotary equipment, and the rotary equipment rotates.

As the amount of torque transmitted between first rotating member 2 and second rotating member 3 increases, first concave portion 2a moves in the circumferential direction relative to connecting member 5, which pushes connecting member 5 toward second concave portion 3a, and causes ends 4a of holding member 4 to deform resiliently. When the amount of torque transmitted between first rotating member 2 and second rotating member 3 is greater than a predetermined torque value, holding member 4 allows connecting member 5 to move in a radial direction. When connecting member 5 moves in the radial direction, connecting member 5 disengages from the wall of first concave portion 2a, such that first rotating member 2 may rotate relative to second rotating member 3. Consequently, the transmission of torque between first rotating member 2 and second rotating member 3 is interrupted.

For example, when the rotary equipment seizes, connecting member 5 allows first rotating member 2 to rotate relative to second rotating member 3, such that excessive torque is not transmitted to the engine or to the endless belt. Moreover, because connecting member 5 is held by holding member 4, connecting member 5 remains within second concave portion 3a when the rotating speed of power transmission 1 is greater than a predetermined rotational speed.

In additional, because the radius of curvature of first concave portion 2a may be greater than the radius of curvature of the first portion of connecting member 5, when the torque is transmitted between first rotating member 2 and second rotating member 3, first concave portion 2a readily may move in the circumferential direction relative to connecting member 5, and when the amount of torque transmitted between first rotating member 2 and second rotating member 3 is greater than the predetermined torque value, the transmission of torque between first rotating member 2 and second rotating member 3 readily may be interrupted.

Further, because holding member 4 is positioned, such that when torque is transmitted between first rotating member 2 and second rotating member 3, connecting member 5 contacts the wall of first concave portion 2a, and when the transmission of such torque is interrupted, connecting member 5 is positioned within second concave portion 3a, the size of power transmission 1 may not increase in the axial direction.

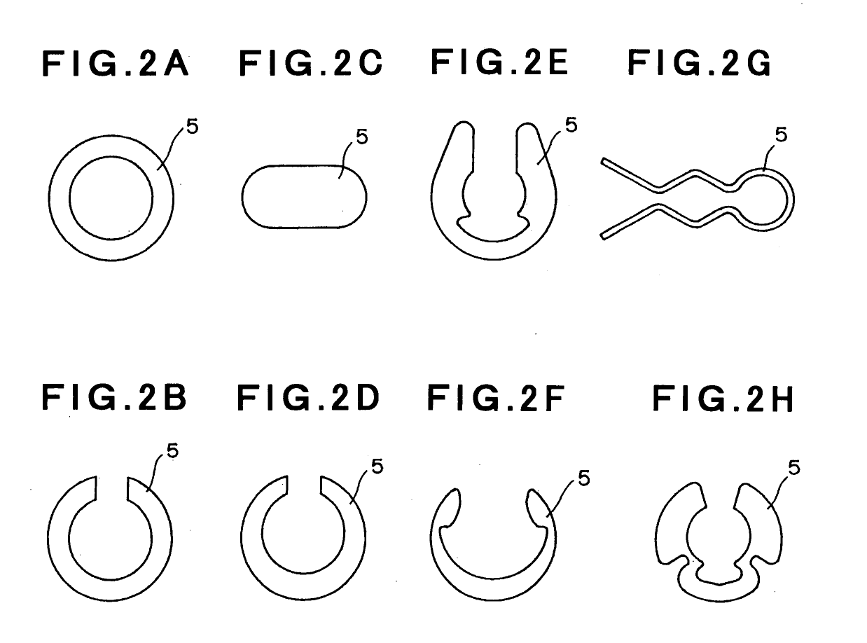

Connecting member 5 may comprise either a rigid body or a resilient body, and connecting member 5 may comprise a metal, a resin, a rubber, or the like. Moreover, connecting member 5 may have any of the shapes depicted in FIGS. 2A-2H, or the like. Further, the radius of curvature of the portion of connecting member 5 positioned within first concave portion 2a may be less than the radius of curvature of first concave portion 2a.

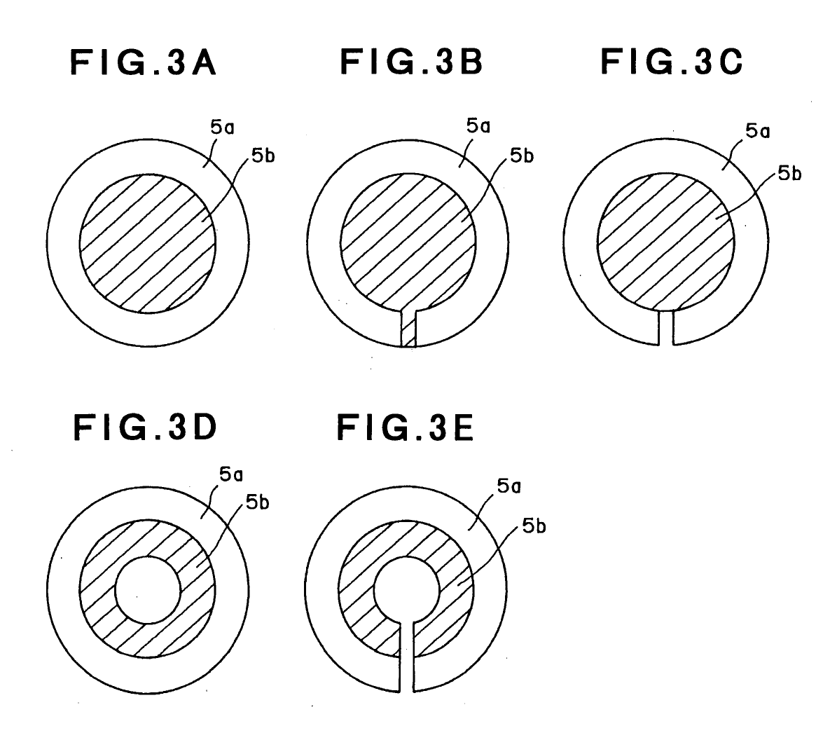

Referring to FIGS. 3A-3E, connecting member 5 may be formed as a composite member having a damping property Specifically, connecting member 5 may comprise a resilient portion 5a and a visco-resilient portion 5b. Resilient portion 5a and visco-resilient portion 5b may suppress a torque variation of the engine of the vehicle and a torsional vibration of a main shaft of the rotary equipment caused by the torque variation. For example, visco-resilient portion 5b may comprise a natural rubber, a synthetic rubber comprising a tackifier or a softener, or the like.

Referring to FIG. 4A, in another embodiment of the present invention, holding member 4 may be semi-ellipse shaped, semi-circular shaped, or the like. In this embodiment, ends 4a of holding member 4 may protrude inward. Referring to FIG. 4B, ends 4a may include a notch portion 4b formed therein.

In another embodiment of the present invention, a lubricant (not shown) may be positioned between first concave portion 2a and connecting member 5 or connecting member 5 may have a self-lubricating property, which may reduce abrasion between first concave portion 2a and connecting member 5. As noted above, the radius of curvature of second concave portion 3a may be greater than the radius of curvature of the portion of connecting member 5 positioned within second concave portion 3a In this embodiment, holding member 4 may be positioned within first concave portion 2a, connecting member 5 may be held by holding member 4, and connecting member 5 may contact second concave portion 3a when torque is transmitted between first rotating member 2 and second rotating member 3.

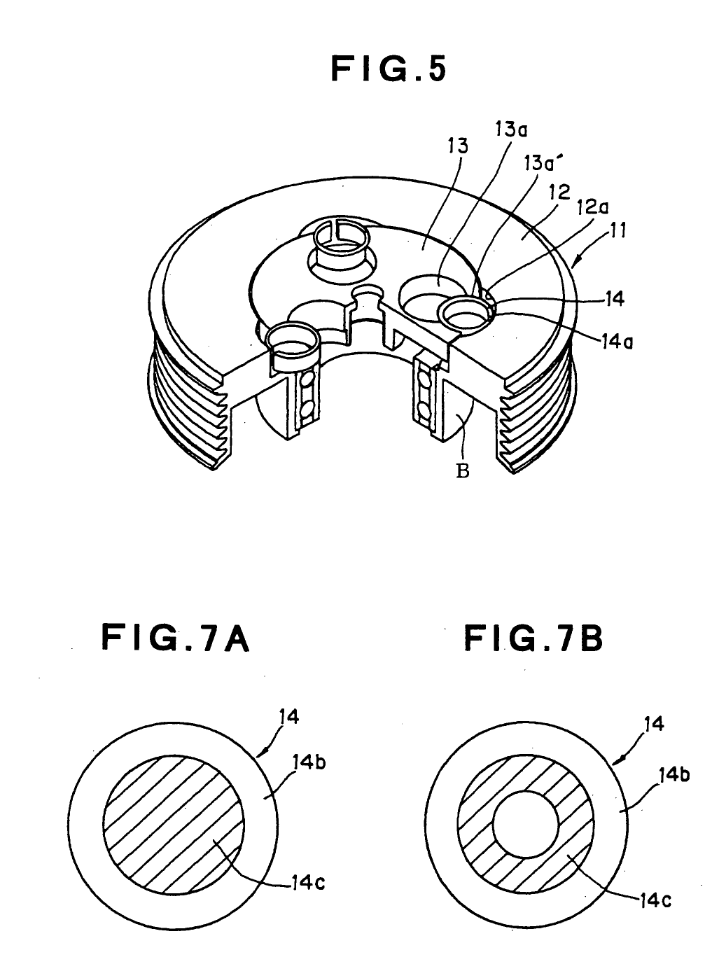

Referring to FIG. 5, a power transmission 11 according to another embodiment of the present invention is depicted. Power transmission 11 may comprise a first rotating member 12, and first rotating member 12 may be supported by a casing of the rotary equipment via a bearing B. First rotating member 12 may have an annular shape, and first rotating member 12 may be connected to the drive source via the endless belt. In this embodiment, at least one first concave portion 12a may be formed on the inner circumferential surface of first rotating member 12. For example, first concave portion 12a may be arc shaped, and first rotating member 12 may include three first concave portions 12a.

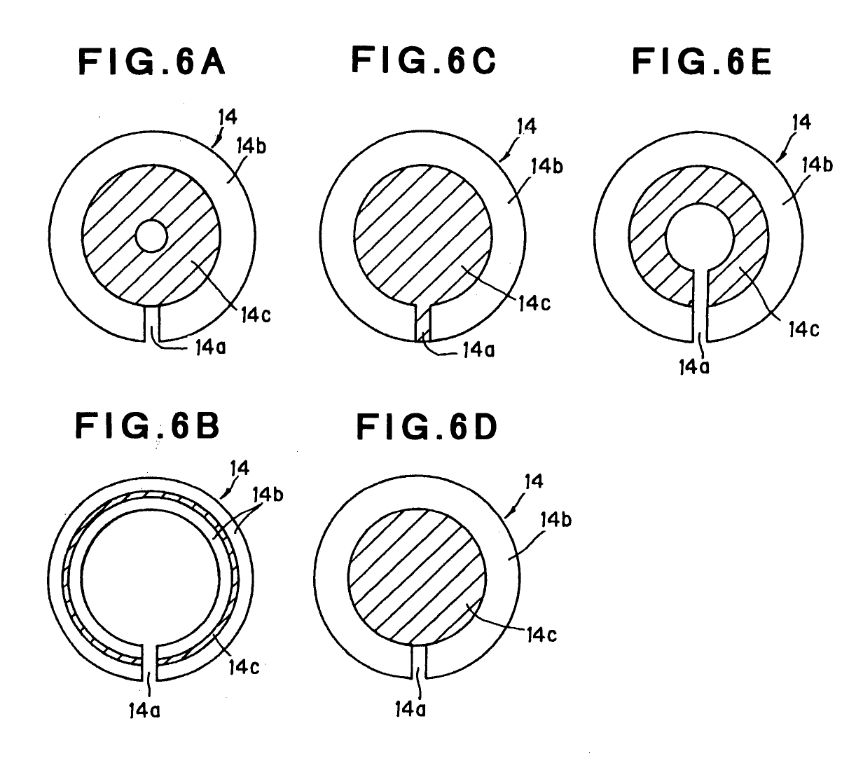

Power transmission 11 also may comprise a second rotating member 13 which is slidably fitted into first rotating member 12. For example, second rotating member 13 may have a disc-like shape. In this embodiment, at least one second concave portion 13a may be formed on the outer circumferential surface of second rotating member 13, such that each second concave portion 13a faces a corresponding one of first concave portions 12a. For example, second rotating member 13 may have a disc-like shape, and second rotating member 13 may include three second concave portions 13a. Moreover, second concave portion 13a may have an entrance portion 13a′ and a width of entrance portion 13a′ may be less than an internal width of second concave portion 13a. Moreover, a main shaft of the rotary equipment may be fixed to the center of second rotating member 13. Power transmission 11 also may comprise a resilient member 14, and resilient member 14 may include a notch 14a formed therethrough. For example, resilient member 14 may have an annular shape. Alternatively, resilient member may have any of the shapes depicted in FIGS. 6A-6E, or the like. Moreover, resilient member 14 may comprise a resilient portion 14b and a visco elastic portion 14c. For example, resilient portion 14b may comprise a metal, a resin, a rubber, or the like, and visco elastic portion 14c may comprise a rubber comprising a tackifier or a softener.

During operation, a torque may be transmitted from the drive source to first rotating member 12 via the endless belt. When the torque transmitted to first rotating member 12 is less than or equal to the predetermined torque valve, resilient member 14 may contact each of a wall of first concave portion 12a and entrance portion 13a′, such that resilient member 14 prevents the relative rotation between first rotating member 12 and second rotating member 13. Consequently, the torque may be transmitted from first rotating member 12 to second rotating member 13 via first concave portion 12a, resilient member 14, and entrance portion 13a′. The torque then may be transmitted from second rotating member 13 to the main shaft of the rotary equipment, and the rotary equipment then may rotate. For example, the portion of resilient member 14 positioned within second concave member 13a may be greater than the portion of resilient member 14 positioned within first concave member 12a.

When the torque transmitted between first rotating member 12 and second rotating member 13 increases, first concave portion 12a may move in the circumferential direction relative to resilient member 14, and resilient member 14 may be pushed in a radially inner direction and may deform resiliently. Resilient member 14 may deform, such that the area of notched portion 14a decreases, and the diameter of resilient member 14 also decreases. When the torque transmitted between first rotating member 12 and second rotating member 13 is greater than the predetermined torque value, resilient member 14 may disengage from the wall of first concave portion 12a, and may enter second concave portion 13a via entrance portion 13a′, which may allow the relative rotation between first rotating member 12 and second rotating member 13. Consequently, the transmission of torque between first rotating member 12 and second rotating member 13 is interrupted.

Some of the advantages of this embodiment of the present invention are substantially the same as the advantages of the above-described embodiments of the present invention. Therefore, the advantages of the above-described embodiments of the present invention are not discussed further with respect to this embodiment of the present invention. In this embodiment of the present invention, because the diameter of resilient member 14 decreases by resilient deformation, resilient member 14 readily may pass through entrance portion 13a′. Referring to FIGS. 7A and 7B, in a modification of this embodiment, resilient member 14 may not include notch 14a, and resilient member 14 readily may pass through entrance portion 13a′ by resilient deformation.

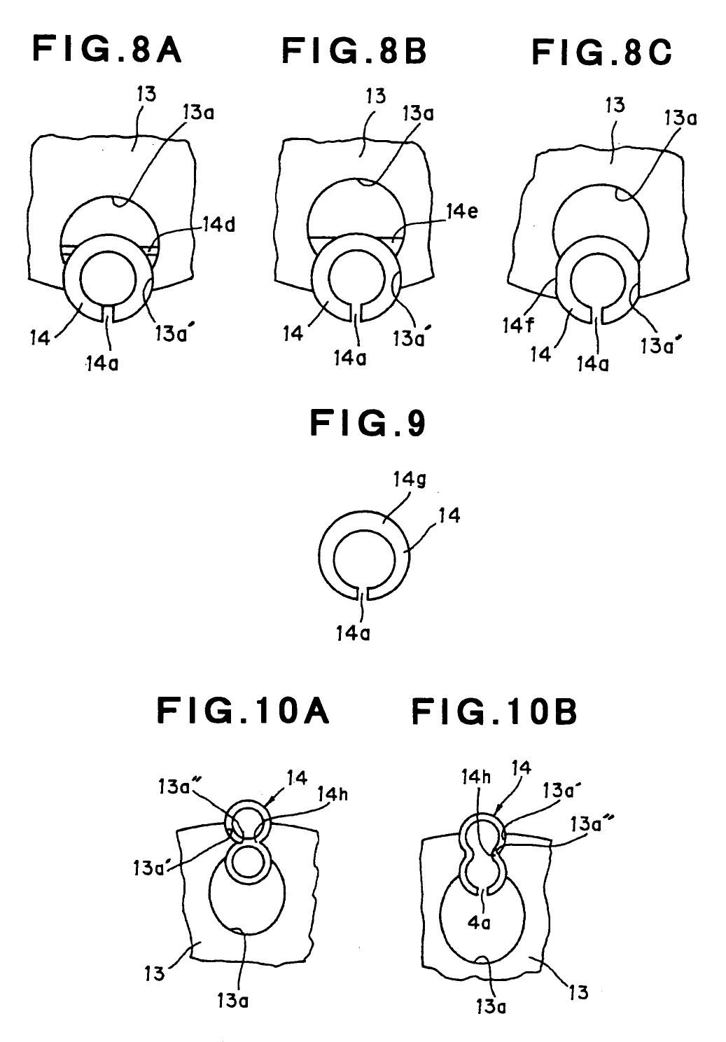

Referring to FIGS. 8A-8C, resilient member 14 also may comprise means for preventing a rotation of resilient member 14. For example, the means for preventing the rotation of resilient member 14a may comprise a projection portion 14d or 14e adapted for engaging second concave portion 13. Referring to FIG. 8C, the means for preventing the rotation of resilient member 14a may comprise a substantially flat contact portion 14f of resilient member 14 and entrance portion 13a. Each of the embodiments depicted in FIGS. 8A-8C may prevent resilient member 14 from rotating. By preventing the rotation of resilient member 14, the predetermined torque value which causes torque interruption may remain substantially constant.

Referring to FIG. 9, a portion 14g of resilient member 14 aligned with notch 14a may be formed thicker than the remains portions of resilient member 14. Because resilient member 14 may deform, such that the area of notch 14a decreases, the flexural stress of the portion 14g may be appropriately released.

Referring to FIGS. 10A and 10B, in another embodiment, entrance portion 13a′ may comprise means for preventing resilient member 14 from disengaging entrance portion 13a′. For example, the means for preventing resilient member 14 from disengaging entrance portion 13a′ may comprise a necking 13a″ formed on entrance portion 13a′, and a necking 14h formed on the portion of resilient member 14 which contacts entrance portion 13a′. With such structures, when power transmission 11 is assembled, resilient member 14 may be prevented from disengaging from entrance portion 13a′.

In another embodiment of the present invention, a lubricant (not shown) may be positioned between first concave portion 12a and resilient member 14, or resilient member 14 may have a self-lubricating property, which may reduce abrasion between first concave portion 12a and resilient member 14. Moreover, the relationship between first concave portion 12a and second concave portion 13a may be reversed. For example, the radius of curvature of second concave portion 13a may be greater than the radius of curvature of the portion of resilient member 14 positioned within second concave portion 13a In this embodiment, resilient member 14 may be positioned within first concave portion 2a, and resilient member 14 may contact second concave portion 13a when the torque is transmitted between first rotating member 12 and second rotating member 13.

The wall surfaces facing each other of entrance portion 13a′ of second concave portion 13a may be formed as a pair of curved surfaces or a pair of flat surfaces in parallel to each other, and further, they may be formed as a pair of flat inclined surfaces in which the gap therebetween is gradually enlarged toward the radially outer direction.

Further, the relationship in size between first concave portion 12a and second concave portion 13a may be reversed. Namely, first concave portion 12a may be formed deep and may have an entrance portion with a small width, and second concave portion 13a may be formed shallow, the radius of curvature of the second concave portion 13a may be set larger than the radius of curvature of a part of resilient member 14 existing in the second concave portion 13a, resilient member 14 may be brought into contact with the second concave portion 13a and the entrance portion of first concave portion 12a, and resilient member 14 may be held by the second concave portion 13a and the entrance portion of the first concave portion 12a. By bringing resilient member 14 into contact with second concave portion 13a and the entrance portion of first concave portion 12a, a torque is transmitted from first rotating member 12 to second rotating member 13. By pushing resilient member 14 by second concave portion 13a, the resilient member 14 passes through the narrow entrance portion and enters into first concave portion 12a, the resilient member 14 leaves from second concave portion 13a, and the torque transmission from first rotating member 12 to second rotating member 13 is interrupted.

While the present invention has been described in connection with preferred embodiments, it will be understood by those skilled in the art that various modifications of the preferred embodiments described above may be made without departing from the scope of the invention. Other embodiments will be apparent to those skilled in the art from a consideration of the specification or from a practice of the invention described herein. It is intended that the specification and the described examples are considered exemplary only, with the true scope of the invention indicated by the following claims.

What is claimed is:

1. A power transmission comprising:
a first rotating member comprising at least one first concave portion formed on an inner circumferential surface of the first rotating member;
a second rotating member comprising at least one second concave portion formed on an outer circumferential surface of the second rotating member;
a holding member positioned within the at least one second concave portion; and
a connecting member slidably held by the holding member, wherein when an amount of torque transmitted to the first rotating member is less than or equal to a predetermined amount of torque a particular portion of the connecting member is in contact with a wall of the at least one first concave portion to prevent a rotation of the first rotating member with respect to the second rotating member, and wherein when the amount of torque transmitted to the first rotating member is greater than the predetermined amount of torque the connecting member is positioned within the at least one second concave portion, the connecting member resiliently deforms the holding member, and the particular portion of the connecting member is disengaged from the wall of the at least one first concave member to allow the first rotation member to rotate with respect to the second rotation member.

2. The power transmission according to claim 1, wherein a radius of curvature of the particular portion of the connecting member is less than a radius of curvature of the at least one first concave portion.

3. The power transmission according to claim 1, wherein the first rotating member is substantially annular shaped, and the second rotating member is substantially disc shaped.

4. The power transmission according to claim 1, wherein the connecting member comprises a rigid member.

5. The power transmission according to claim 1, wherein the connecting member comprises a resilient member.

6. The power transmission according to claim 1, wherein the connecting member comprises means for dampening.

7. The power transmission according to claim 1, wherein the at least one first concave portion comprises three first concave portions, and the at least one second concave portion comprises three second concave portions.

8. The power transmission according to claim 1, further comprising a lubrication layer formed between the particular portion of the connecting member and the at least one first concave portion.

9. The power transmission according to claim 1, wherein the particular portion of the connecting member is self-lubricating.

10. A power transmission comprising:
a first rotating member comprising at least one first concave portion formed on an inner circumferential surface of the first rotating member;
a second rotating member comprising at least one second concave portion formed on an outer circumferential surface of the second rotating member;
a holding member positioned within the at least one first concave portion; and
a connecting member slidably held by the holding member, wherein when an amount of torque transmitted to the first rotating member is less than or equal to a predetermined amount of torque a particular portion of the connecting member is in contact with a wall of the at least one second concave portion to prevent a rotation of the first rotating member with respect to the second rotating member, and wherein when the amount of torque transmitted to the first rotating member is greater than the predetermined amount of torque the connecting member is positioned within the at least one first concave portion, the connecting member resiliently deforms the holding member, and the particular portion of the connecting member is disengaged from the wall of the at least one second concave member to allow the first rotation member to rotate with respect to the second rotation member.

11. The power transmission according to claim 10, wherein a radius of curvature of the particular portion of the connecting member is less than a radius of curvature of the at least one second concave portion.

12. The power transmission according to claim 10, wherein the first rotating member is substantially annular shaped, and the second rotating member is substantially disc shaped.

13. The power transmission according to claim 10, wherein the connecting member comprises a rigid member.

14. The power transmission according to claim 10, wherein the connecting member comprises a resilient member.

15. The power transmission according to claim 10, wherein the connecting member comprises means for dampening.

16. The power transmission according to claim 10, wherein the at least one first concave portion comprises three first concave portions, and the at least one second concave portion comprises three second concave portions.

17. The power transmission according to claim 10, further comprising a lubrication layer formed between the particular portion of the connecting member and the at least one second concave portion.

18. The power transmission according to claim 10, wherein the particular portion of the connecting member is self-lubricating.

19. A power transmission comprising:
a first rotating member comprising at least one first concave portion formed on an inner circumferential surface of the first rotating member;
a second rotating member comprising at least one second concave portion formed on an outer circumferential surface of the second rotating member, wherein the at least one second concave portion comprises an entrance portion having a width which is less than an interior width of the at least one second concave portion; and
a resilient member slidably held by the entrance portion, wherein the resilient member comprises means for damping, wherein when an amount of torque transmitted to the first rotating member is less than or equal to a predetermined amount of torque a particular portion of the resilient member is in contact with a wall of the at least one first concave portion to prevent a rotation of the first rotating member with respect to the second rotating member, and wherein when the amount of torque transmitted to the first rotating member is greater than the predetermined amount of torque the resilient member is positioned within the at least one second concave portion, the at least one first concave portion resiliently deforms the resilient member, and the particular portion of the resilient member is disengaged from the wall of the at least one first concave member to allow the first rotation member to rotate with respect to the second rotation member.

20. The power transmission according to claim 19, wherein the resilient member comprises:
a body portion comprising a visco-elastic material or an elastic material; and
a clad portion comprising a visco-elastic material.

21. The power transmission according to claim 19, wherein the resilient member comprises an annular member, and the means for damping comprises a notch formed through the annular member, wherein the first rotating member is substantially annular shaped, and the second rotating member is substantially disc shaped.

22. The power transmission according to claim 19, wherein the resilient member comprises an annular member, and the means for damping comprises a notch formed through the annular member and a first portion of the resilient member having a thickness which is greater than a thickness of a second portion of the resilient member, wherein first portion of the resilient member is aligned with the notch.

23. The power transmission according to claim 19, further comprising means for preventing the resilient member from disengaging from the entrance portion.

24. The power transmission according to claim 19, further comprising a lubrication layer formed between the particular portion of the connecting member and the wall of the at least one first concave portion.

25. The power transmission according to claim 19, wherein the particular portion of the connecting member is self-lubricating.

26. A power transmission comprising:
a first rotating member comprising at least one first concave portion formed on an inner circumferential surface of the first rotating member, wherein the at least one first concave portion comprises an entrance portion having a width which is less than an interior width of the at least one first concave portion;
a second rotating member comprising at least one second concave portion formed on an outer circumferential surface of the second rotating member; and
a resilient member slidably held by the entrance portion, wherein the resilient member comprises means for damping, wherein when an amount of torque transmitted to the first rotating member is less than or equal to a predetermined amount of torque a particular portion of the resilient member is in contact with a wall of the at least one second concave portion to prevent a rotation of the first rotating member with respect to the second rotating member, and wherein when the amount of torque transmitted to the first rotating member is greater than the predetermined amount of torque the resilient member is positioned within the at least one first concave portion, the at least one second concave portion resiliently deforms the resilient member, and the particular portion of the resilient member is disengaged from the wall of the at least one second concave member to allow the first rotation member to rotate with respect to the second rotation member.

27. The power transmission according to claim 26, wherein the resilient member comprises:
a body portion comprising a visco-elastic material or an elastic material; and
a clad portion comprising a visco-elastic material.

28. The power transmission according to claim 26, wherein the resilient member comprises an annular member, and the means for damping comprises a notch formed through the annular member, wherein the first rotating member is substantially annular shaped, and the second rotating member is substantially disc shaped.

29. The power transmission according to claim 26, wherein the resilient member comprises an annular member, and the means for damping comprises a notch formed through the annular member and a first portion of the resilient member having a thickness which is greater than a thickness of a second portion of the resilient member, wherein first portion of the resilient member is aligned with the notch.

30. The power transmission according to claim 26, further comprising means for preventing the resilient member from disengaging from the entrance portion.

31. The power transmission according to claim 26, further comprising a lubrication layer formed between the particular portion of the connecting member and the wall of the at least one second concave portion.

32. The power transmission according to claim 26, wherein the particular portion of the connecting member is self-lubricating.

33. A power transmission comprising:
a first rotating member comprising at least one first concave portion formed on an inner circumferential surface of the first rotating member;
a second rotating member comprising at least one second concave portion formed on an outer circumferential surface of the second rotating member, wherein the at least one second concave portion comprises an entrance portion having a width which is less than an interior width of the at least one second concave portion; and
a resilient member slidably held by the entrance portion, wherein the resilient member comprises means for preventing the resilient member from rotating, wherein when an amount of torque transmitted to the first rotating member is less than or equal to a predetermined amount of torque a particular portion of the resilient member is in contact with a wall of the at least one first concave portion to prevent a rotation of the first rotating member with respect to the second rotating member, and wherein when the amount of torque transmitted to the first rotating member is greater than the predetermined amount of torque the resilient member is positioned within the at least one second concave portion, the at least one first concave portion resiliently deforms the resilient member, and the particular portion of the resilient member is disengaged from the wall of the at least one first concave member to allow the first rotation member to rotate with respect to the second rotation member.

34. The power transmission according to claim 33, wherein the resilient member comprises:
a body portion comprising a visco-elastic material or an elastic material; and
a clad portion comprising a visco-elastic material.

35. The power transmission according to claim 33, wherein the resilient member comprises an annular member or an annular member having a notch formed therein, wherein the first rotating member is substantially annular shaped, and the second rotating member is substantially disc shaped.

36. The power transmission according to claim 33, wherein the resilient member comprises an annular member having a notch formed therein, wherein the thickness of a first portion of the resilient member, which is aligned with the notch, is greater than a second portion of the resilient member.

37. The power transmission according to claim 33, further comprising means for preventing the resilient member from disengaging from the entrance portion.

38. The power transmission according to claim 33, further comprising a lubrication layer formed between the particular portion of the connecting member and the wall of the at least one first concave portion.

39. The power transmission according to claim 33, wherein the particular portion of the connecting member is self-lubricating.

40. A power transmission comprising:
a first rotating member comprising at least one first concave portion formed on an inner circumferential surface of the first rotating member, wherein the at least one first concave portion comprises an entrance portion having a width which is less than an interior width of the at least one first concave portion;
a second rotating member comprising at least one second concave portion formed on an outer circumferential surface of the second rotating member; and
a resilient member slidably held by the entrance portion, wherein the resilient member comprises means for preventing the resilient member from rotating, wherein when an amount of torque transmitted to the first rotating member is less than or equal to a predetermined amount of torque a particular portion of the resilient member is in contact with a wall of the at least one second concave portion to prevent a rotation of the first rotating member with respect to the second rotating member, and wherein when the amount of torque transmitted to the first rotating member is greater than the predetermined amount of torque the resilient member is positioned within the at least one first concave portion, the at least one second concave portion resiliently deforms the resilient member, and the particular portion of the resilient member is disengaged from the wall of the at least one second concave member to allow the first rotation member to rotate with respect to the second rotation member.

41. The power transmission according to claim 40, wherein the resilient member comprises:
a body portion comprising a visco-elastic material or an elastic material; and
a clad portion comprising a visco-elastic material.

42. The power transmission according to claim 40, wherein the resilient member comprises an annular member or an annular member having a notch formed therein, wherein the first rotating member is substantially annular shaped, and the second rotating member is substantially disc shaped.

43. The power transmission according to claim 40, wherein the resilient member comprises an annular member having a notch formed therein, wherein the thickness of a first portion of the resilient member, which is aligned with the notch, is greater than a second portion of the resilient member.

44. The power transmission according to claim 40, further comprising means for preventing the resilient member from disengaging from the entrance portion.

45. The power transmission according to claim 40, further comprising a lubrication layer formed between the particular portion of the connecting member and the wall of the at least one second concave portion.

46. The power transmission according to claim 40, wherein the particular portion of the connecting member is self-lubricating.
